(19) United States
(12) Patent Application Publication
(10) Pub. No.: US 2015/0185479 A1
(43) Pub. Date: Jul. 2, 2015

(54) HELMET

(71) Applicant: HON HAI PRECISION INDUSTRY CO., LTD., New Taipei (TW)

(72) Inventor: GUAN-JIUN WANG, New Taipei (TW)

(21) Appl. No.: 14/585,407

(22) Filed: Dec. 30, 2014

(30) Foreign Application Priority Data
Dec. 31, 2013 (TW) 102149367

(51) Int. Cl. G02B 27/01; G06K 9/00; H04M 1/00; G06F 3/16; H04M 1/725

(52) U.S. Cl. CPC G02B 27/017; G06F 3/167; H04M 1/7253; H04M 1/006; G06K 9/00791

(57) ABSTRACT

A helmet can include a helmet body and a control system coupled to the helmet body. The helmet body can include a main body, a visor coupled to the main body, and two earphones coupled to opposite sides of the main body. Each of the earphones can include a headset configured to wirelessly couple to an external communication device. The control system can include a control module coupled to the main body, an input module coupled to the control module, and a display module coupled to the control module. The display module can include an incoming display coupled to the visor. The control module can be configured to couple to the external communication device.

### FIELD

The subject matter herein generally relates to helmets, and particularly relates to a motorcycle helmet.

### BACKGROUND

A motorcyclist should wear a helmet, configured to improve safety when driving.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a front elevational view of an embodiment of a helmet including a display and a control system.

FIG. 2 is a right-side elevational view of the helmet of FIG. 1.

FIG. 3 is a rear elevational view of the helmet of FIG. 1.

FIG. 4 is a diagrammatic sketch of the display of the helmet of FIG. 1.

FIG. 5 is a block diagram of a control system of the helmet of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to helmets, and particularly relates to a motorcycle helmet.

A helmet can include a helmet body and a control system coupled to the helmet body. The helmet body can include a main body, a windscreen coupled to the main body, and two earphones coupled to opposite sides of the main body. Each of the earphones can include a headset configured to wirelessly couple to an external communication device. The control system can include a control module coupled to the main body, an input module coupled to the control module, and a display module coupled to the control module. The display module can include an incoming display coupled to the visor. The control module can be configured to couple to the external communication device. The control module can be configured to receive information of a call coming into the external communication device, and to control the incoming display to display the information. The input module can be configured to receive a voice command from a user of the communication device, and to transfer the voice command to the control module. Such that the control module can be capable of controlling the communication device to answer or hang up the call according to the voice command.

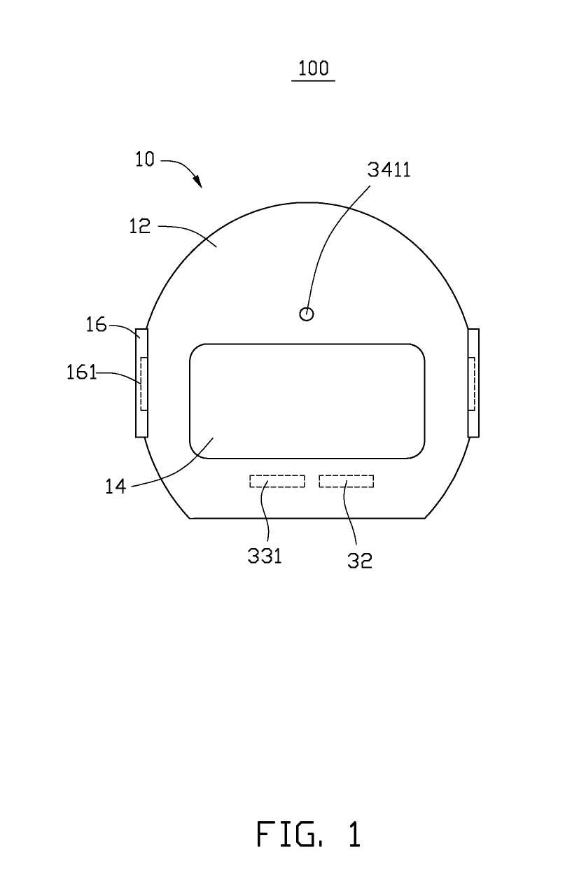

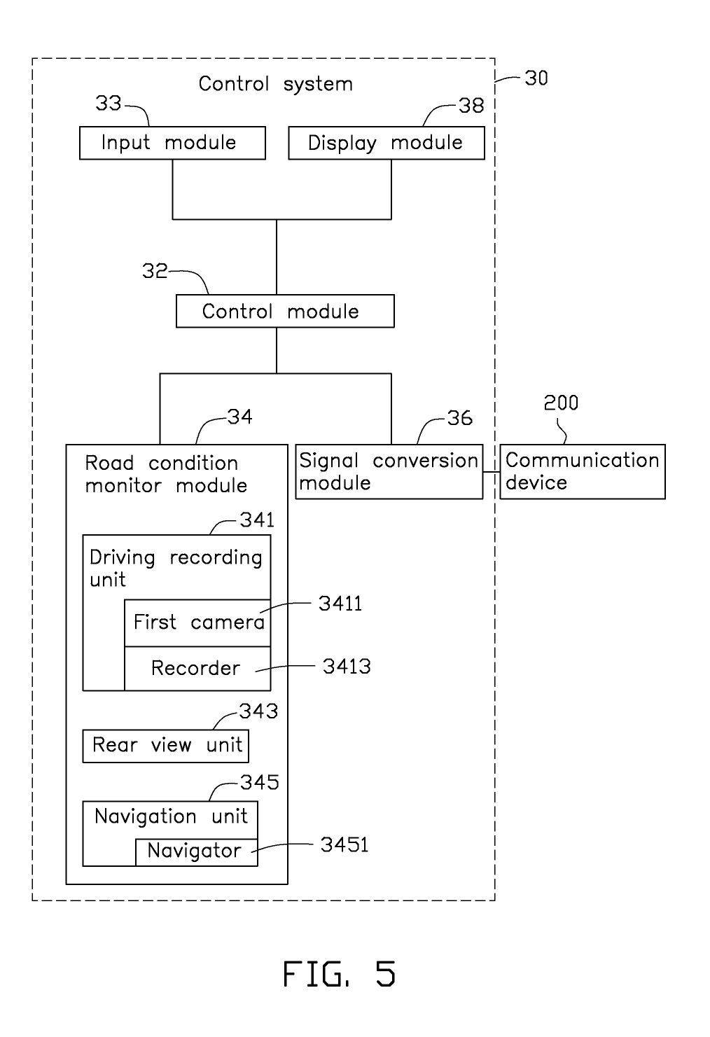

FIG. 1 illustrates an embodiment of a helmet 100 configured to be used by motorcyclists or cyclists. The helmet 100 can include a helmet body 10 and a control system 30 (shown in FIG. 5) coupled to the helmet 100.

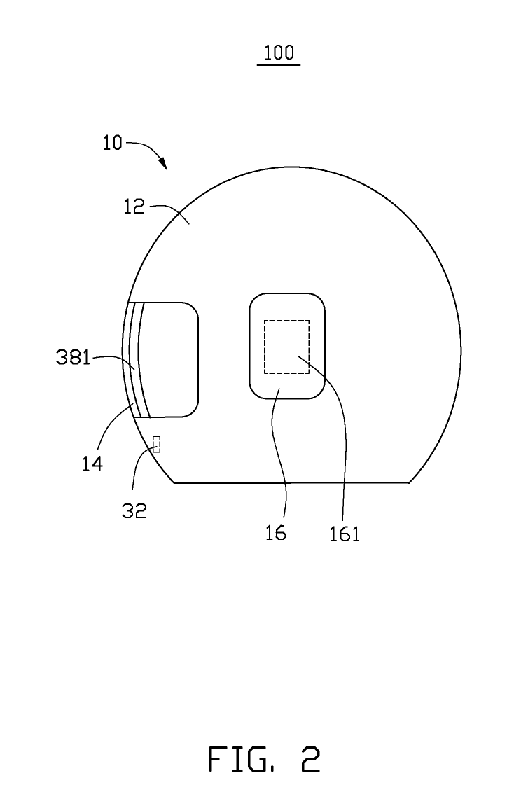

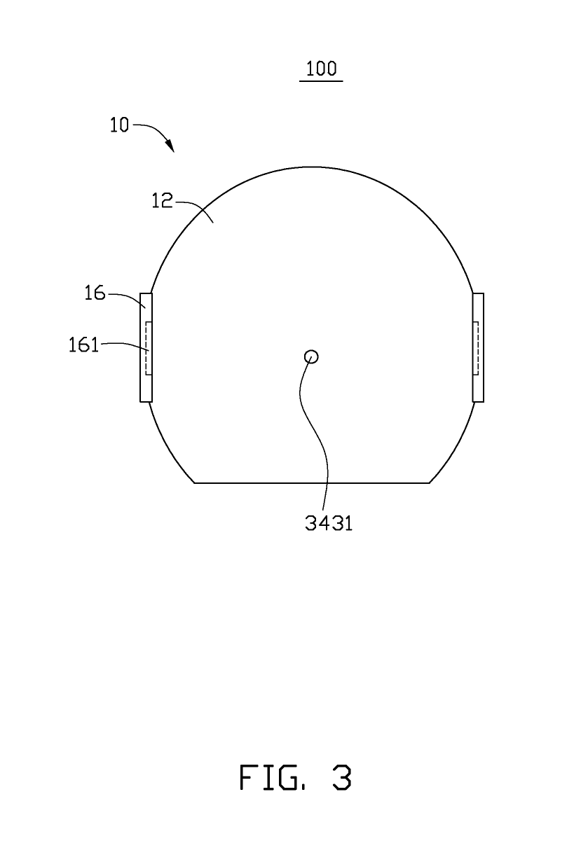

FIGS. 2-3 illustrate that the helmet body 10 can include a main body 12, a visor 14 coupled to the main body 12, and two earphones 16 respectively coupled to opposite sides of the main body 12.

The visor 14 can be mounted in front of the main body 12. The visor 14 can be made of transparent materials, such as glass, plastic, and the like. In the illustrated embodiment, the visor 14 is glass. In an alternative embodiment, the visor 14 can be made of translucent glass material with color. In another alternative embodiment, the visor 14 can be covered by a film with color.

Each of the earphones 16 can include a headset 161. The headset 161 can be a wireless headset, and configured to electrically connect with an external communication device 200 (shown in FIG. 5) such as but not limited to, a mobile phone. When the communication device 200 receives a call, the headset 161 can ring. The headset 161 can be configured to act as a headphone of the communication device 200 when the user answers the call. In an alternative embodiment, there can be only one headset 161.

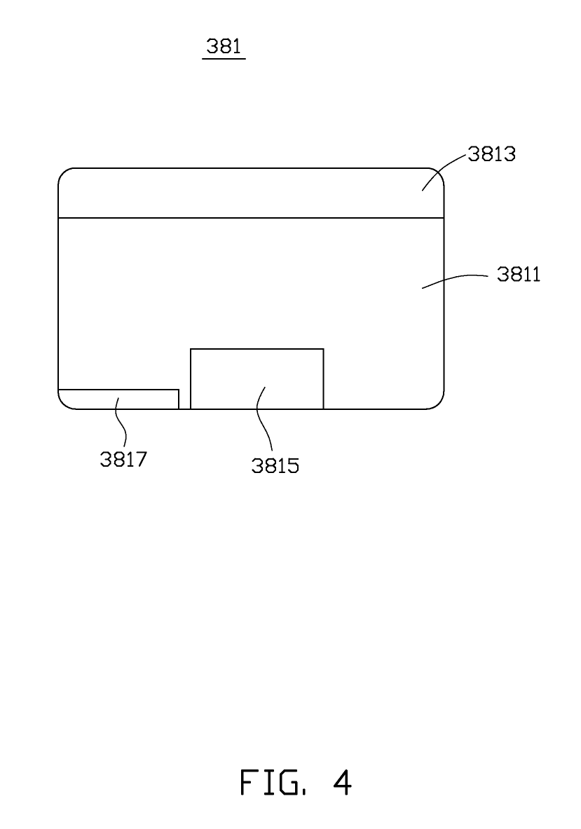

FIGS. 4 and 5 illustrate that the control system 30 can be a voice control system. The control system 30 can include a control module 32, an input module 33, a road condition monitor module 34, a signal conversion module 36, and a display module 38. The input module 33, the road condition monitor module 34, the signal conversion module 36, and the display module 38 can be respectively electronically connected to the control module 32.

The control module 32 can be mounted in the main body 12 adjacent to the visor 14. The control module 32 can be in signal communication with the external communication device 200, and configured to receive a signal of the call coming into the communication device 200. In the illustrated embodiment, the control module 32 can be in wireless communication with the communication device 200.

The input module 33 can be mounted to the main body 12 adjacent to the control module 32, configured to receive a voice command from the user, and transfer the signal of the voice command to the control module 32. The input module 33 can include a microphone 331 (shown in FIG. 1). The microphone 331 can be mounted to the main body 12 adjacent to the visor 14. The microphone 331 can be configured to receive a voice command from the user, and transfer a signal of the voice command to the control module 32. The microphone 331 can further be configured to wirelessly connect with the communication device 200, when the user answers the call.

The road condition monitor module 34 can include a driving recording unit 341, a rear view unit 343, and a navigation unit 345.

The driving recording unit 341 can be configured to record the moving status when the user is driving. The driving recording unit 341 can include a first camera 3411 and a recorder 3413. The first camera 3411 can be mounted to the front surface of the main body 12 adjacent to the visor 14. The recorder 3413 can be mounted to the motorcycle or to the bicycle, and can communicate signals with the first camera 3411. In the illustrated embodiment, the recorder 3413 can be wirelessly connected to the first camera 3411. In an alternative embodiment, the recorder 3413 can be mounted to the main body 12 and directly coupled to the first camera 3411. The first camera 3411 can be configured to record the moving status, and transfer information of the moving status to the recorder 3413. The recorder 3413 can be configured to store the information into a memory.

The rear view unit 341 can be electrically connected to the control module 32. The control module 32 can be configured to control the rear view unit 341 to take a video of the road condition behind the user, and show the video to the user. The rear view unit 341 can include a second camera 3411 (shown in FIG. 3). The second camera 3411 can be mounted on a rear surface of the main body 12, and be configured to take a video of the road condition.

The navigation unit 345 can include a navigator 3451 mounted to the motorcycle or the bicycle. The navigator 3451 can be wirelessly connected to the control module 32. The control module 32 can be configured to obtain information of the navigation, and show the information to the user. In an alternative embodiment, the navigator 3451 can be mounted to the main body 12 and directly coupled to the control module 32.

The signal conversion module 36 can be configured to wirelessly connect with the communication device 200, and to receive the information of the incoming call to the control module 32, the information can be such as, but not limited to, a phone number of the caller, or a name of the caller.

FIG. 4 illustrates that the display module 38 can be configured to display the road condition, the navigation, and the information of the call, enabling obtainment by the user. The display module 38 can include a display 381 fixed to a side of the visor 14 facing the inside of the main body 12. The display 381 can be a transparent screen. The display 381 can include a main screen 3811, a rear view display 3813, a navigation display 3815, and an incoming display 3817.

The main screen 3811 can be a transparent screen, and can be layered on the visor 14. The rear view display 3813 can be positioned at an upper edge of the main display 3811, and electronically connected to the control module 32. The rear view display 3813 can be configured to display the road condition behind the user when controlled by the control module 32. The navigation display 3815 can be positioned at a lower edge of the main screen 3811, and electronically connected to the control module 32. The navigation display 3815 can be configured to display a picture of navigation when controlled by the control module 32. When the user inputs a voice command to the input module 33, the input module 33 can be configured to convert the voice command into a signal and transfer the signal to the control module 32. The control module 32 can be configured to turn on or turn off the rear view display 3813 and the navigation display 3815 according to the voice command.

The incoming display 3817 can be positioned adjacent to the navigation display 3813 and electronically connected to the control module 32. The incoming display 3817 can be configured to display the information of the call coming into the communication device 200 when controlled by the control module 32.

In operation, the main body 10 can be worn on the head of the user; the control system 30 can be started and wirelessly connected to the communication device 200. When a receiving an incoming call, the headsets 161 can ring to remind the user of the incoming call, the signal conversion module 36 can receive the information of the incoming call and transfer the information to the control module 32. The control module 32 can display the information of the call on the incoming display 3817. The information can be a phone number or a name of the incoming call. The user can input a voice command to answer the call or hang up the call via the microphone 331 of the input module 33, according to the information. The input module 33 can receive and transfer the voice command to the control module 32. The control module 32 can control the signal conversion module 36 to convert the voice command into a signal that can be received by the communication device 200. The signal conversion module 200 can transfer the signal of the voice command to the communication device 20, enabling the communication device 200 to answer or hang up the call according to the voice command.

When the user needs to watch the road condition behind, a voice command can be input to the microphone 331; the input module 33 can transfer the voice command to the control module 32. The control module 32 can start the second camera 3431, and control the rear view display 3813 to display the video of the road condition recorded by the second camera 3431. Similarly, the navigation module 38 can be controlled to turn on or turn off by the control module 32 according to voice commands of the user.

In an alternative embodiment, the signal conversion module 36 can be omitted. The control module 32 can be directly coupled to the communication device 200, and can be configured to receive the information of the incoming call, and receive and transfer the voice command to the communication device 200.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A helmet comprising:
a helmet body comprising:
a main body;
a visor coupled to the main body; and
at least one earphone coupled to a side of the main body, the at least one earphone having a headset configured to wirelessly coupled to an external communication device; and
a control system comprising:
a control module coupled to the main body and configured to couple to the external communication device;
an input module coupled to the control module; and
a display module coupled to the control module and comprising:
an incoming display coupled to the visor;
the control module is configured to receive information of a call coming into the external communication device, and to control the incoming display to display the information;
the input module is configured to receive a voice command from a user of the communication device, and to transfer the voice command to the control module, such that the control module configured to control the communication device to answer or hang up the call according to the voice command.

2. The helmet of claim 1, wherein the input module comprises a microphone coupled to the main body and adjacent to the visor; and the microphone is configured to receive the voice command.

3. The helmet of claim 1, wherein the control system further comprises a signal conversion unit configured to wirelessly couple to the communication device and to receive and transfer the information of the call coming into the communication device to the control module.

4. The helmet of claim 1, wherein the control system further comprises a driving recording unit, the driving recording unit comprises a first camera coupled to a front surface of the main body, and a recorder coupled to the first camera; the first camera is configured to record a moving status of the user, and transfer information of the moving status to the recorder; the recorder is configure to store the information.

5. The helmet of claim 1, wherein the display module further comprises a transparent main screen coupled to the visor; and the incoming display is positioned at an edge of the main screen.

6. The helmet of claim 5, wherein the control system further comprises a rear view unit coupled to the control module, the display module further comprises a rear view display positioned at an upper edge of the main screen; the control module is configured to control the rear view unit to take a video of a road condition behind the user, and the rear view display is configured to display the road condition recorded by the rear view unit.

7. The helmet of claim 6, wherein the rear view unit further comprises a rear view unit comprises a second camera mounted to a rear surface of the main body; the rear view unit is configured to take a video of the road condition behind the user when controlled by the control module.

8. The helmet of claim 5, wherein the control system further comprises a navigation unit coupled to the control module; the display module further comprises a navigation display coupled to the main screen adjacent to the incoming display; the control module is configured obtain information of the navigation unit and control the navigation display to display the information.

9. The helmet of claim 8, wherein the navigation unit comprises a navigator wirelessly coupled to the control module.

10. The helmet of claim 1, wherein each of the headset is a wireless headset.

11. A helmet comprising:
a helmet body comprising:
a main body;
a visor coupled to the main body; and
at least one headset coupled to the main body, configured to wirelessly coupled to an external communication device; and
a control system comprising:
a control module coupled to the main body, and configured to couple to the external communication device;
an input module coupled to the control module; and
a display module coupled to the control module and comprising:
an incoming display coupled to the visor; wherein, the control module is configured to receive information of a call coming into the external communication device, and to control the incoming display to display the information; the input module is configured to receive a voice command from a user of the communication device, and to transfer the voice command to the control module, such that the control module is capable of controlling the communication device to answer or hang up the call according to the voice command.

12. The helmet of claim 11, wherein the input module comprises a microphone coupled to the main body and adjacent to the visor; the microphone is configured to receive the voice command.

13. The helmet of claim 11, wherein the control system further comprises a signal conversion unit configured to wirelessly couple to the communication device and to receive and transfer the information of the call coming into the communication device to the control module.

14. The helmet of claim 11, wherein the control system further comprises a driving recording unit, the driving recording unit comprises a first camera coupled to a front surface of the main body, and a recorder coupled to the first camera; the first camera is configured to record a moving status of the user, and transfer information of the moving status to the recorder; the recorder is configure to store the information.

15. The helmet of claim 11, wherein the display module further comprises a transparent main screen coupled to the visor; the incoming display is positioned at an edge of the main screen.

16. The helmet of claim 15, wherein the control system further comprises a rear view unit coupled to the control module, the display module further comprises a rear view display positioned at an upper edge of the main screen; the control module is configured to control the rear view unit to take a video of a road condition behind the user, and the rear view display is configured to display the road condition recorded by the rear view unit.

17. The helmet of claim 16, wherein the rear view unit further comprises a rear view unit comprises a second camera mounted to a rear surface of the main body; the rear view unit is configured to take a video of the road condition behind the user when controlled by the control module.

18. The helmet of claim 15, wherein the control system further comprises a navigation unit coupled to the control module; the display module further comprises a navigation display coupled to the main screen adjacent to the incoming display; the control module is configured obtain information of the navigation unit and control the navigation display to display the information.

19. The helmet of claim 18, wherein the navigation unit comprises a navigator wirelessly coupled to the control module.

20. A helmet comprising:
a helmet body comprising:
a main body;
a visor coupled to the main body; and
at least one headset coupled to the main body; and
a control system comprising:
a control module coupled to the main body;
an input module coupled to the control module; and
a display module coupled to the control module and comprising an incoming display coupled to the visor.
